(19) United States
(12) Patent Application Publication
(10) Pub. No.: US 2025/0205721 A1
(43) Pub. Date: Jun. 26, 2025

(54) PUMP COSMETIC BOTTLE

(71) Applicant: EUN SUK LEE, Jiangsu (CN)

(72) Inventors: EUN SUK LEE, Jiangsu (CN); FA LI, Jiangsu (CN)

(21) Appl. No.: 18/930,215

(22) Filed: Oct. 29, 2024

(30) Foreign Application Priority Data
Dec. 22, 2023 (CN) 202323517449U

(51) Int. Cl. B05B 11/10; A45D 40/00

(52) U.S. Cl. CPC B05B 11/1047; A45D 40/00; B05B 11/1001; B05B 11/1067; A45D 2200/056

(57) ABSTRACT

A pump cosmetic bottle includes a bottle body, a bottle cap and a pump mounted on the bottle body. The bottle body includes an inner bottle, an outer bottle sheathing the inner bottle, and a bottle shoulder sheathing the inner bottle and the outer bottle. The inner bottle includes an inner bottle body, and an inner bottle mouth connected on the upper end face of the inner bottle body and communicating with the inner bottle body. The outer diameter of the inner bottle body is greater than that of the inner bottle mouth. The bottle shoulder includes an inner shoulder sheathing the pump, and an outer shoulder of which an inner side face of the upper end is connected to the outer periphery of the inner shoulder and the lower end is connected to the outer side of the upper end of the outer bottle in a fixed manner.

### CROSS-REFERENCE TO RELATED APPLICATION AND CLAIM OF PRIORITY

This application claims the benefit under 35 USC § 119 of Chinese Patent Application No. CN202323517449U, filed on Dec. 22, 2023, in the Chinese Patent Intellectual Property Office, the entire disclosure of which is incorporated herein by reference for all purposes.

### BACKGROUND

### 1. Technical Field

The present invention relates to a pump cosmetic bottle.

### 2. Background Art

Cosmetic bottles are intended to hold cosmetics. According to the forms and use methods of cosmetics, cosmetic bottles are primarily classified into pressing bottles, spray bottles and cream bottle. Emulsion cosmetics are mainly kept in pressing bottles. The existing cosmetic bottles are prone to problems of sticking and uneven discharge when pressed.

### SUMMARY

An aspect of the present invention is to provide a pump cosmetic bottle that can achieve smooth pressing and a stable discharge volume.

In order to achieve the foregoing aspect, the present invention adopts the following technical scheme: a pump cosmetic bottle, including a bottle body, a bottle cap and a pump mounted on the bottle body, which includes an inner bottle, an outer bottle sheathing the inner bottle, and a bottle shoulder sheathing the inner bottle and the outer bottle, the inner bottle includes an inner bottle body, and an inner bottle mouth connected on the upper end face of the inner bottle body and communicating with the inner bottle body, the outer diameter of the inner bottle body is greater than that of the inner bottle mouth, the bottle shoulder includes an inner shoulder sheathing the pump, and an outer shoulder of which an inner side face of the upper end is connected to the outer periphery of the inner shoulder and the lower end is connected to the outer side of the upper end of the outer bottle in a fixed manner, the diameter of the outer periphery of the bottle cap first increases uniformly and then decreases uniformly from top to bottom until it is equal to the outer diameter of the upper end face of the outer shoulder, the outer diameter of the outer shoulder first increases uniformly at a first growth rate and then remains unchanged or increases uniformly at a second growth rate from top to bottom, and when the outer diameter of the outer shoulder increases uniformly at the second growth rate, the second growth rate is lower than the first growth rate.

In another embodiment, the bottle cap includes an inner cap body and an outer cap body, which sheaths the inner cap body and of which the lower end is connected to the lower end of the inner cap body, a clearance is formed between the inner cap body and the outer cap body, the inner cap body has an annular edge, which is on the periphery of the lower end of the inner cap and extends diagonally upward, and the lower end of the outer cap body is inserted between the annular edge of the inner cap body and the outer periphery of the lower end of the inner cap body.

In another embodiment, the annular lower end face of the inner shoulder is against the upper end face of the inner bottle body.

In another embodiment, the pump includes a pump cylinder, which passes through the inside of the inner bottle mouth and of which the upper end is arranged on the upper end face of the inner bottle mouth, a pump valve sheathed with the upper end of the pump cylinder in a vertically slidable manner, a pump piston sheathing the pump valve and located inside the upper end of the pump cylinder, a pump limit sleeve sheathing the inner bottle mouth and connected to the inner bottle mouth in a threaded manner, and a pump pressing component, which sheaths the pump valve and of which the lower end is against the pump limit sleeve, a discharge channel is arranged on the pump pressing component, a discharge hole is arranged on the pump valve, the discharge channel communicates with the inside of the pump cylinder through the inside of the pump valve and the discharge hole, and the bottom of the pump cylinder is provided with a check valve that allows materials to enter the pump cylinder from the inner bottle body only.

In another embodiment, the pump limit sleeve has an inner limit ring, which is pressed against the pump piston, and the pump piston is pressed against a convex ring on an outer side wall of the pump valve.

In another embodiment, the pump pressing component includes a pump core connecting rod that sheaths the pump valve, a pump nozzle, which sheaths the pump core connecting rod and of which the lower end is located inside the inner shoulder, and an elastic part arranged between a second convex ring on the periphery of the upper end of the pump core connecting rod and the upper end face of the pump limit sleeve, the pump valve and the pump core connecting rod can slide individually, a third convex ring and a single ring slot are arranged between the pump valve and the pump core connecting rod, the elastic part makes the pump core connecting rod have a tendency of upward movement all the time, the pump core connecting rod drives the pump valve and the pump nozzle to have a tendency of upward movement all the time, and the pump valve drives the piston to have a tendency of upward movement all the time.

In another embodiment, the inner bottle body is provided with a bottle piston, the bottom of the inner bottle body communicates with the inside of the outer bottle, and the bottle piston divides the inner bottle body into an upper part communicable with the pump cylinder and a lower part communicating with the outer bottle all the time.

In another embodiment, the elastic part is a telescopic tube or a number of support pieces extending spirally.

Due to the application of the foregoing technical scheme, the present invention has the following advantages over the prior art: The sheathing of the bottle shoulder with the inner bottle body and the outer bottle, respectively ensures the coaxiality of the inner bottle with the outer bottle and the pump during installation and achieves the effect of smooth pressing of the pump. Due to the smooth pressing, the discharge volume of the pump nozzle can also remain stable.

### BRIEF DESCRIPTION OF THE DRAWINGS

FIG. 1 is a structural schematic view of a pump cosmetic bottle provided by the present invention;

FIG. 2 is a structural schematic view of the pump cosmetic bottle provided by the present invention in an initial state;

FIG. 3 is a structural schematic view of the pump cosmetic bottle provided by the present invention at the initial stage of a pressing stroke;

FIG. 4 is a structural schematic view of the pump cosmetic bottle provided by the present invention at the end of the pressing stroke

FIG. 5 is a structural schematic view of the pump cosmetic bottle provided by the present invention at an ascending initiation stage.

### DETAILED DESCRIPTION

Below, the present invention is further described in conjunction with the embodiments shown in the accompanying drawings.

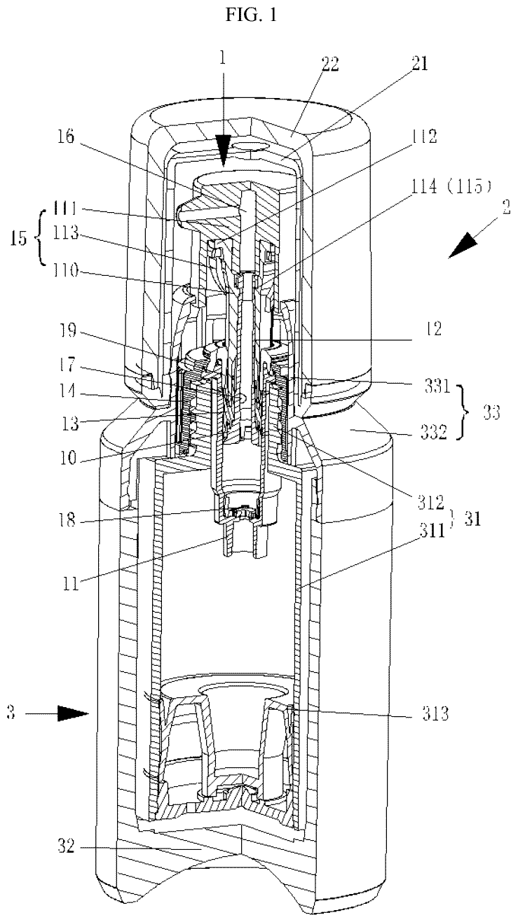

As shown in FIG. 1, a pump cosmetic bottle includes a bottle body 3, a bottle cap 2 and a pump 1 mounted on the bottle body 3.

Specifically, the bottle body 3 includes an inner bottle 31, an outer bottle 32 sheathing the inner bottle 31, and a bottle shoulder 33 sheathing the inner bottle 31 and the outer bottle 32, the inner bottle 31 includes an inner bottle body 311, and an inner bottle mouth 312 connected on the upper end face of the inner bottle body 311 and communicating with the inner bottle body 311, the outer diameter of the inner bottle body 311 is greater than that of the inner bottle mouth 312, the bottle shoulder 33 includes an inner shoulder 331 sheathing the pump 1, and an outer shoulder 332 of which an inner side face of the upper end is connected to the outer periphery of the inner shoulder and the lower end is connected to the outer side of the upper end of the outer bottle 32 in a fixed manner, the diameter of the outer periphery of the bottle cap 2 first increases uniformly and then decreases uniformly from top to bottom until it is equal to the outer diameter of the upper end face of the outer shoulder 332, the outer diameter of the outer shoulder 332 first increases uniformly at a first growth rate and then remains unchanged or increases uniformly at a second growth rate from top to bottom, and when the outer diameter of the outer shoulder 332 increases uniformly at the second growth rate, the second growth rate is lower than the first growth rate. The bottle cap 2 includes an inner cap body 21 and an outer cap body 22, which sheaths the inner cap body 21 and of which the lower end is connected to the lower end of the inner cap body 21, a clearance is formed between the inner cap body 21 and the outer cap body 22, the inner cap body 21 has an annular edge, which is on the periphery of the lower end of the inner cap and extends diagonally upward, and the lower end of the outer cap body 22 is inserted between the annular edge of the inner cap body 21 and the outer periphery of the lower end of the inner cap body 21. The annular lower end face of the inner shoulder 331 is against the upper end face of the inner bottle body 311.

The pump 1 includes a pump cylinder 11, which passes through the inside of the inner bottle mouth 312 and of which the upper end is arranged on the upper end face of the inner bottle mouth 312, a pump valve 12 sheathed with the upper end of the pump cylinder 11 in a vertically slidable manner, a pump piston 13 sheathing the pump valve 12 and located inside the upper end of the pump cylinder 11, a pump limit sleeve 14 sheathing the inner bottle mouth 312 and connected to the inner bottle mouth 312 in a threaded manner, and a pump pressing component 15, which sheaths the pump valve 12 and of which the lower end is against the pump limit sleeve 14, a discharge channel 16 is arranged on the pump pressing component 15, a discharge hole is arranged on the pump valve 12, the discharge channel 16 communicates with the inside of the pump cylinder 11 through the inside of the pump valve 12 and the discharge hole 17, and the bottom of the pump cylinder 11 is provided with a check valve 18 that allows materials to enter the pump cylinder 11 from the inner bottle body 311 only. The pump limit sleeve 14 has an inner limit ring 19, which is pressed against the pump piston 13, and the pump piston 13 is pressed against a convex ring 10 on an outer side wall of the pump valve 12.

The pump pressing component 15 includes a pump core connecting rod 10 that sheaths the pump valve 12, a pump nozzle 111, which sheaths the pump core connecting rod 110 and of which the lower end is located inside the inner shoulder 331, and an elastic part 113 arranged between a second convex ring 112 on the periphery of the upper end of the pump core connecting rod 110 and the upper end face of the pump limit sleeve 14, the pump valve 12 and the pump core connecting rod can slide individually, a third convex ring 114 and a single ring slot 115 are arranged between the pump valve 12 and the pump core connecting rod, the elastic part 113 makes the pump core connecting rod 110 have a tendency of upward movement all the time, the elastic part 113 is a telescopic tube or a number of support pieces extending spirally, the pump core connecting rod drives the pump valve 12 and the pump nozzle to have a tendency of upward movement all the time, and the pump valve 12 drives the piston to have a tendency of upward movement all the time. The inner bottle body 311 is provided with a bottle piston 313, the bottom of the inner bottle body 311 communicates with the inside of the outer bottle 32, and the bottle piston divides the inner bottle body 311 into an upper part communicable with the pump cylinder 11 and a lower part communicating with the outer bottle 32 all the time.

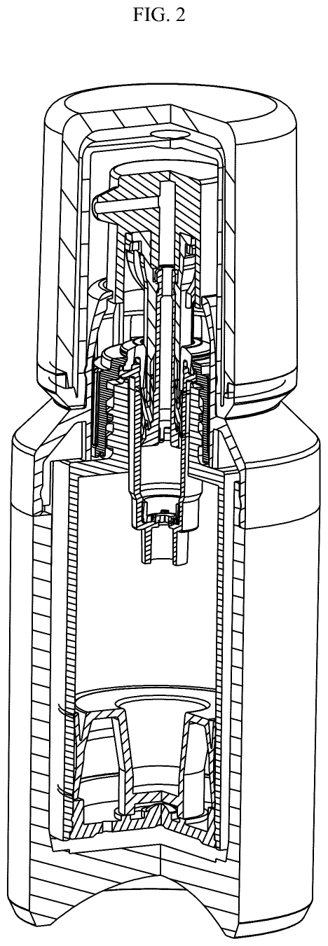

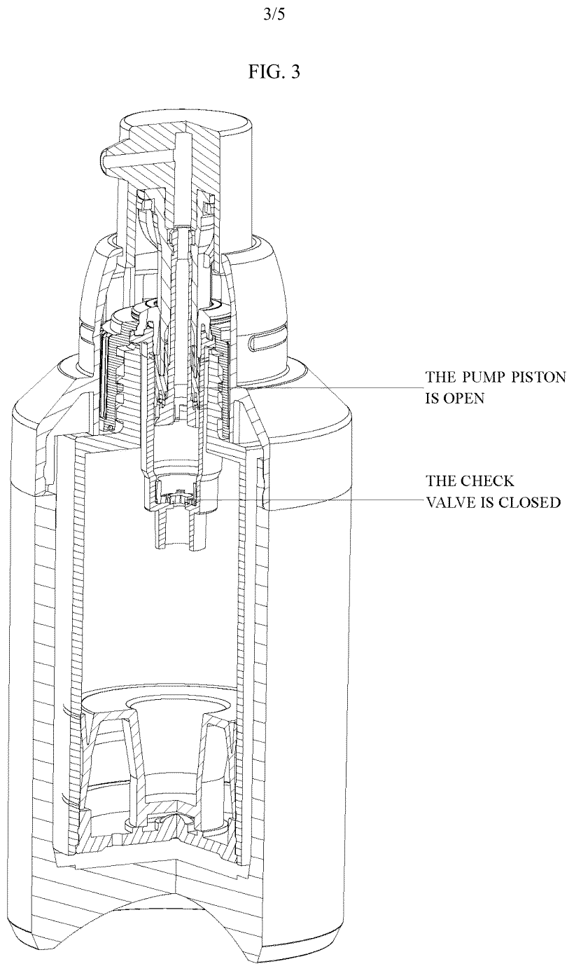

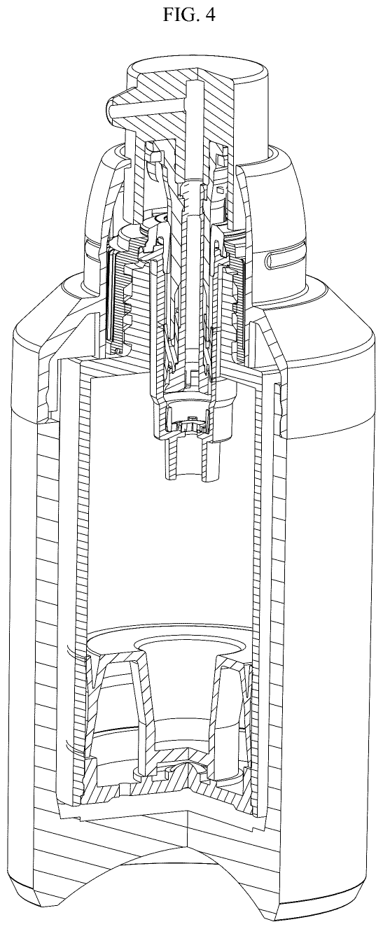

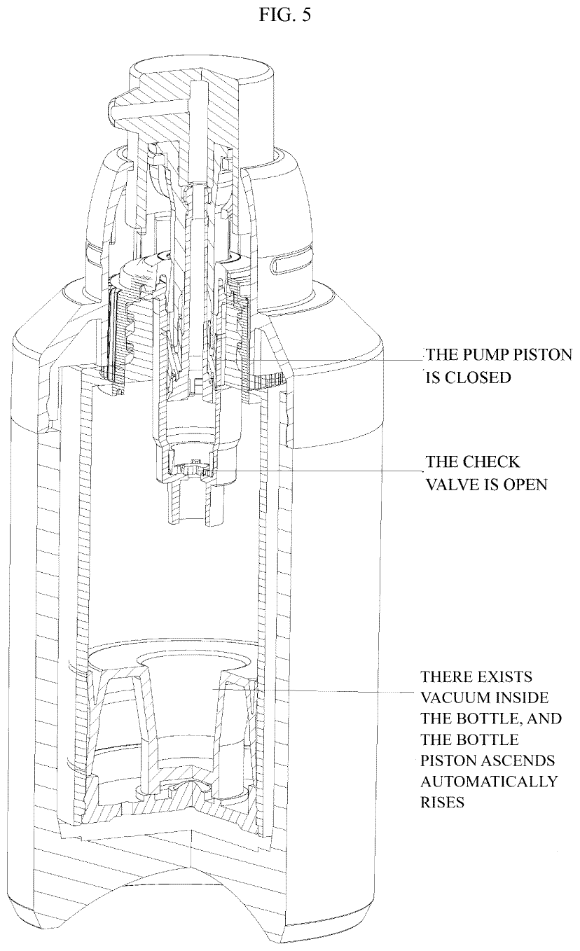

As shown in FIG. 2, the check valve is closed, and the pump piston is closed; as shown in FIG. 3, at the initial stage of a pressing stroke, the pump piston is open and the check valve is closed to press out the cosmetics inside the pump cylinder; as shown in FIG. 4, the pressing stroke ends; as shown in FIG. 5, at the ascending initiation stage, the piston is closed. When the ascending continues, a negative pressure is formed in the cylinder, and the check valve is open to suck the cosmetics in the bottle up. In the next pressing stroke, the material can be pumped out. With the decrease of the material, the bottle piston ascends gradually, driving the material inside the bottom to ascend. The operation is repeated in this way.

The above embodiments are only for illustrating the technical concept and features of the present invention, aim to enable those familiar with this technology to understand the content of the present invention and implement it accordingly, and are not intended to limit the protection scope of the present invention. All equivalent changes or modifications made according to the spirit of the present invention shall be within the protection scope of the present invention.

What is claimed is:

1. A pump cosmetic bottle comprising:
a bottle body;
a bottle cap; and
a pump mounted on the bottle body, the pump comprising:
an inner bottle comprising an inner bottle body and an inner bottle mouth connected on an upper end face of the inner bottle body and communicating with the inner bottle body, wherein the outer diameter of the inner bottle body is greater than that of the inner bottle mouth;
an outer bottle configured for sheathing the inner bottle; and
a bottle shoulder configured for sheathing the inner bottle and the outer bottle, wherein the bottle shoulder the bottle shoulder comprises an inner shoulder sheathing the pump, and an outer shoulder of which an inner side face of the upper end is connected to the outer periphery of the inner shoulder and the lower end is connected to the outer side of the upper end of the outer bottle in a fixed manner, the diameter of the outer periphery of the bottle cap first increases uniformly and then decreases uniformly from top to bottom until it is equal to the outer diameter of the upper end face of the outer shoulder, the outer diameter of the outer shoulder first increases uniformly at a first growth rate and then remains unchanged or increases uniformly at a second growth rate from top to bottom, and when the outer diameter of the outer shoulder increases uniformly at the second growth rate, the second growth rate is lower than the first growth rate.

2. The pump cosmetic bottle according to claim 1, wherein the bottle cap comprises:
an inner cap body; and
an outer cap body which is configured to sheath the inner cap body and of which a lower end is connected to a lower end of the inner cap body,
wherein a clearance is formed between the inner cap body and the outer cap body, the inner cap body has an annular edge, which is on the periphery of the lower end of the inner cap and extends diagonally upward, and the lower end of the outer cap body is inserted between the annular edge of the inner cap body and the outer periphery of the lower end of the inner cap body.

3. The pump cosmetic bottle according to claim 1, wherein the annular lower end face of the inner shoulder is against the upper end face of the inner bottle body.

4. The pump cosmetic bottle according to claim 1, wherein the pump comprises:
a pump cylinder, which passes through the inside of the inner bottle mouth and of which the upper end is arranged on the upper end face of the inner bottle mouth;
a pump valve sheathed with the upper end of the pump cylinder in a vertically slidable manner;
a pump piston sheathing the pump valve and located inside the upper end of the pump cylinder;
a pump limit sleeve sheathing the inner bottle mouth and connected to the inner bottle mouth in a threaded manner; and a pump pressing component, which sheaths the pump valve and of which the lower end is against the pump limit sleeve,
wherein a discharge channel is arranged on the pump pressing component;
a discharge hole is arranged on the pump valve;
the discharge channel communicates with the inside of the pump cylinder through the inside of the pump valve and the discharge hole; and
the bottom of the pump cylinder is provided with a check valve that allows materials to enter the pump cylinder from the inner bottle body only.

5. The pump cosmetic bottle according to claim 4, wherein the pump limit sleeve has an inner limit ring, which is pressed against the pump piston, and the pump piston is pressed against a first convex ring on an outer side wall of the pump valve.

6. The pump cosmetic bottle according to claim 4, wherein the pump pressing component comprises:
a pump core connecting rod that sheaths the pump valve;
a pump nozzle, which sheaths the pump core connecting rod and of which the lower end is located inside the inner shoulder; and
an elastic part arranged between a second convex ring on the periphery of the upper end of the pump core connecting rod and the upper end face of the pump limit sleeve, wherein the pump valve and the pump core connecting rod are configured to be capable of sliding individually;
a third convex ring and a single ring slot are arranged between the pump valve and the pump core connecting rod;
the elastic part is configured to make the pump core connecting rod have a tendency of upward movement all the time;
the pump core connecting rod is configured to drive the pump valve and the pump nozzle to have a tendency of upward movement all the time; and
the pump valve is configured to drive the piston to have a tendency of upward movement all the time.

7. The pump cosmetic bottle according to claim 4, wherein the inner bottle body is provided with a bottle piston;
the bottom of the inner bottle body communicates with the inside of the outer bottle; and
the bottle piston divides the inner bottle body into an upper part communicable with the pump cylinder and a lower part communicating with the outer bottle all the time.

8. The pump cosmetic bottle according to claim 6, wherein the elastic part is a telescopic tube or a number of support pieces extending spirally.
